(19) United States
(12) Patent Application Publication
(10) Pub. No.: US 2024/0386299 A1
(43) Pub. Date: Nov. 21, 2024

(54) SYSTEMS AND METHODS OF ANTICIPATORY REMOTE PARKING PICK-UP

(71) Applicants: Hyundai Motor Company, Seoul (KR); Kia Corporation, Seoul (KR)

(72) Inventors: Yacer Mirza, Superior Township, MI (US); Joseph E. Steffey, Superior Township, MI (US); Kevin S. Vidal, Superior Township, MI (US); Matthew Baker, Superior Township, MI (US); Ilyaas Vaid, Superior Township, MI (US)

(21) Appl. No.: 18/198,679

(22) Filed: May 17, 2023

(51) Int. Cl. G06N 5/045; B60W 60/00; G06Q 50/30

(52) U.S. Cl. CPC G06N 5/045; B60W 60/00253; G06Q 50/40

(57) ABSTRACT

Systems and methods for performing anticipatory detection of a user's need to be picked up by an autonomous vehicle (AV) are provided. The method may comprise, using a computing device, comprising a processor and a memory, determining a location of an AV, determining whether a pick-up is required at the location, when a pick-up is required at the location, collecting data pertaining to a user and a destination, based on the data, calculating a trigger value indicative of a percent likelihood that a pick-up request is required, determining whether the trigger value is greater than a threshold value, and, when the trigger value is greater than the threshold value, triggering the pick-up, causing the AV to perform the pick-up.

### BACKGROUND

### Technical Field

Embodiments of the present disclosure relate to systems and methods for performing anticipatory detection of a user's need to be picked up by an autonomous vehicle and performing one or more vehicle actions in conjunction with this anticipatory detection.

### Background

Autonomous vehicles are generally capable of autonomously traveling to one or more locations absent active steering, acceleration, and deceleration from a user. With these capabilities, autonomous vehicles generally have the capability of picking up a user at a desired location. However, current systems and methods require a user to make an active and conscious input, communicating with the autonomous vehicle and making a request for the autonomous vehicle to pick up one or more passengers/users.

Currently, all ride-hailing and vehicle pick-up services require a user input. This leads to inefficiency and the use of conscious effort. User inputs comprise, but are not limited to, information pertaining to pick-up time, pick-up location, drop-off time, drop-off location, and/or other suitable information. This requires the user to plan out their pick-up and, if not done preemptively, the user will not be picked up at the optimal time and the user will be frustrated with the late pick-up Additionally, if it is done too early, the autonomous vehicle will wait for the user for an extended amount of time, which may lead to increased traffic and congestion.

For at least these reasons, systems and methods for performing anticipatory detection of a user's need to be picked up by an autonomous vehicle, allowing the autonomous vehicle to anticipate a user's need for a pick-up without a need for an active input, is needed.

### SUMMARY

According to an object of the present disclosure, a method for performing anticipatory detection of a user's need to be picked up by an autonomous vehicle (AV) is provided. The method may comprise, using a computing device, comprising a processor and a memory, determining a location of an AV, determining whether a pick-up is required at the location, when a pick-up is required at the location, collecting data pertaining to a user and a destination, based on the data, calculating a trigger value indicative of a percent likelihood that a pick-up request is required, determining whether the trigger value is greater than a threshold value, and, when the trigger value is greater than the threshold value, triggering the pick-up, causing the AV to perform the pick-up.

According to an exemplary embodiment, the determining the location of the AV may comprise determining whether the AV is parked.

According to an exemplary embodiment, the determining whether a pick-up is required at the location may comprise determining whether the parking location meets predefined criteria.

According to an exemplary embodiment, the data pertaining to the user may comprise one or more of the following: user digital behavior data, user physiological data (e.g. blood sugar, perspiration, and the like); user voice recognition data; user payment histories; and user historical travel data.

According to an exemplary embodiment, the data pertaining to the destination may comprise one or more of the following: historical data comprising whether the user has been to the destination before, an average timeframe of how long the user has visited the destination during a trip to the destination, and an average timeframe of how long an average customer visits the destination during a trip to the destination, data pertaining to whether the destination is an establishment, and, when the destination is an establishment, hours of operation of the establishment.

According to an exemplary embodiment, the calculating the trigger value may comprise performing one or more calculation parameters based on the data to dynamically adjust the trigger value.

According to an exemplary embodiment, wherein the method may further comprise, when the trigger value is not greater than the threshold value, recalculating the trigger value.

According to an object of the present disclosure, a system for performing anticipatory detection of a user's need to be picked up by an AV is provided. The system may comprise an AV, comprising a processor, a memory, and one or more location sensors. The processor may be configured to determine, using the one or more location sensors, a location of the AV, determine whether a pick-up is required at the location, when a pick-up is required at the location, collect data pertaining to a user and a destination, based on the data, calculate a trigger value indicative of a percent likelihood that a pick-up request is required, determine whether the trigger value is greater than a threshold value, and, when the trigger value is greater than the threshold value, trigger the pick-up, causing the AV to perform the pick-up.

According to an exemplary embodiment, the determining the location of the AV may comprise determining whether the AV is parked.

According to an exemplary embodiment, the determining whether a pick-up is required at the location may comprise determining whether the parking location meets predefined criteria.

According to an exemplary embodiment, the data pertaining to the user may comprise one or more of the following: user digital behavior data; user physiological data (e.g. blood sugar, perspiration, and the like); user voice recognition data; user payment histories; and user historical travel data.

According to an exemplary embodiment, the data pertaining to the destination may comprise one or more of the following: historical data comprising whether the user has been to the destination before, an average timeframe of how long the user has visited the destination during a trip to the destination, and an average timeframe of how long an average customer visits the destination during a trip to the destination, data pertaining to whether the destination is an establishment, and, when the destination is an establishment, hours of operation of the establishment.

According to an exemplary embodiment, the calculating the trigger value may comprise performing one or more calculation parameters based on the data to dynamically adjust the trigger value.

According to an exemplary embodiment, when the trigger value is not greater than the threshold value, the processor may be further configured to recalculate the trigger value.

According to an object of the present disclosure, a system for performing anticipatory detection of a user's need to be picked up by an AV is provided. The system may comprise an AV comprising one or more location sensors, and a computing device, comprising a processor and a memory, configured to store programming instructions. The programming instructions, when executed by the processor, may be configured to cause the processor to determine, using the one or more location sensors, a location of the AV, determine whether a pick-up is required at the location, when a pick-up is required at the location, collect data pertaining to a user and a destination, based on the data, calculate a trigger value indicative of a percent likelihood that a pick-up request is required, determine whether the trigger value is greater than a threshold value, and, when the trigger value is greater than the threshold value, trigger the pick-up, causing the AV to perform the pick-up.

According to an exemplary embodiment, the determining the location of the AV may comprise determining whether the AV is parked.

According to an exemplary embodiment, the determining whether a pick-up is required at the location may comprise determining whether the parking location meets predefined criteria.

According to an exemplary embodiment, the data pertaining to the user may comprise one or more of the following: user digital behavior data; user physiological data (e.g. blood sugar, perspiration, and the like); user voice recognition data; user payment histories; and user historical travel data.

According to an exemplary embodiment, the data pertaining to the destination may comprise one or more of the following historical data comprising whether the user has been to the destination before, an average timeframe of how long the user has visited the destination during a trip to the destination, and an average timeframe of how long an average customer visits the destination during a trip to the destination, data pertaining to whether the destination is an establishment, and, when the destination is an establishment, hours of operation of the establishment.

According to an exemplary embodiment, the calculating the trigger value may comprise performing one or more calculation parameters based on the data to dynamically adjust the trigger value.

According to an exemplary embodiment, when the trigger value is not greater than the threshold value, the programming instructions, when executed, may be configured to further cause the processor to recalculate the trigger value.

### BRIEF DESCRIPTION OF THE DRAWINGS

The accompanying drawings, which are incorporated in and form a part of the Detailed Description, illustrate various non-limiting and non-exhaustive embodiments of the subject matter and, together with the Detailed Description, serve to explain principles of the subject matter discussed below. Unless specifically noted, the drawings referred to in this Brief Description of Drawings should be understood as not being drawn to scale and like reference numerals refer to like parts throughout the various figures unless otherwise specified.

FIG. 1 illustrates a vehicle configured to perform anticipatory detection of a user's need to be picked up by an autonomous vehicle and perform one or more vehicle actions in conjunction with this anticipatory detection, according to an exemplary embodiment of the present disclosure.

FIG. 2 illustrates a logic schematic for performing anticipatory detection of a user's need to be picked up by an autonomous vehicle and performing one or more vehicle actions in conjunction with this anticipatory detection, according to an exemplary embodiment of the present disclosure.

FIG. 3 illustrates a flowchart of a method for performing anticipatory detection of a user's need to be picked up by an autonomous vehicle and performing one or more vehicle actions in conjunction with this anticipatory detection, according to an exemplary embodiment of the present disclosure.

FIG. 4 illustrates example elements of a computing device, according to an exemplary embodiment of the present disclosure.

FIG. 5 illustrates an example architecture of a vehicle, according to an exemplary embodiment of the present disclosure.

### DETAILED DESCRIPTION

The following Detailed Description is merely provided by way of example and not of limitation. Furthermore, there is no intention to be bound by any expressed or implied theory presented in the preceding background or in the following Detailed Description.

Reference will now be made in detail to various exemplary embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications, and equivalents, which may be included within the spirit and scope of the various embodiments as defined by the appended claims. Furthermore, in this Detailed Description, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

Some portions of the detailed descriptions which follow are presented in terms of procedures, logic blocks, processing, and other symbolic representations of operations on data within an electrical device. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities may take the form of electrical or magnetic signals capable of being stored, transferred, combined, compared, and otherwise manipulated in an electronic system, device, and/or component.

It should be borne in mind, however, that these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “determining,” “communicating,” “taking,” “comparing,” “monitoring,” “calibrating,” “estimating,” “initiating,” “providing,” “receiving,” “controlling,” “transmitting,” “isolating,” “generating,” “aligning,” “synchronizing,” “identifying,” “maintaining,” “displaying,” “switching,” or the like, refer to the actions and processes of an electronic item such as, a processor, a sensor processing unit (SPU), a processor of a sensor processing unit, an application processor of an electronic device/system, or the like, or a combination thereof. The item manipulates and transforms data represented as physical (electronic and/or magnetic) quantities within the registers and memories into other data similarly represented as physical quantities within memories or registers or other such information storage, transmission, processing, or display components.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles. In aspects, a vehicle may comprise an internal combustion engine system as disclosed herein.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising.” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Embodiments described herein may be discussed in the general context of processor-executable instructions residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, logic, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example device vibration sensing system and/or electronic device described herein may include components other than those shown, including well-known components.

Various techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may comprise random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

Various embodiments described herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), a programmable logic controller (PLC), a complex programmable logic device (CPLD), a discrete gate or transistor logic, discrete hardware components, or any combination thereof designed to perform the functions described herein, or other equivalent integrated or discrete logic circuitry. The term “processor,” as used herein may refer to any of the foregoing structures or any other structure suitable for implementation of the techniques described herein. As employed in the subject specification, the term “processor” can refer to substantially any computing processing unit or device comprising, but not limited to comprising, single-core processors, single-processors with software multithread execution capability; multi-core processors, multi-core processors with software multithread execution capability; multi-core processors with hardware multithread technology; parallel platforms; and parallel platforms with distributed shared memory. Moreover, processors can exploit nano-scale architectures such as, but not limited to, molecular and quantum-dot based transistors, switches and gates, in order to optimize space usage or enhance performance of user equipment. A processor may also be implemented as a combination of computing processing units.

In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration. One or more components of an SPU or electronic device described herein may be embodied in the form of one or more of a “chip,” a “package,” an Integrated Circuit (IC).

According to an exemplary embodiment, systems and methods are provided for performing anticipatory detection of a user's need to be picked up by an autonomous vehicle and performing one or more vehicle actions in conjunction with this anticipatory detection without a need for an active input, improving both convenience and efficiency of vehicle autonomy.

Existing ride-hailing/vehicle pick-up services require the active input of a user to request a pick-up. According to an exemplary embodiment, the systems and methods of the present disclosure do not require any conscious user input, nor are they limited to location or time constraints. Furthermore, according to an exemplary embodiment, systems and methods of the present disclosure do not require the need for any additional sensors on the vehicle.

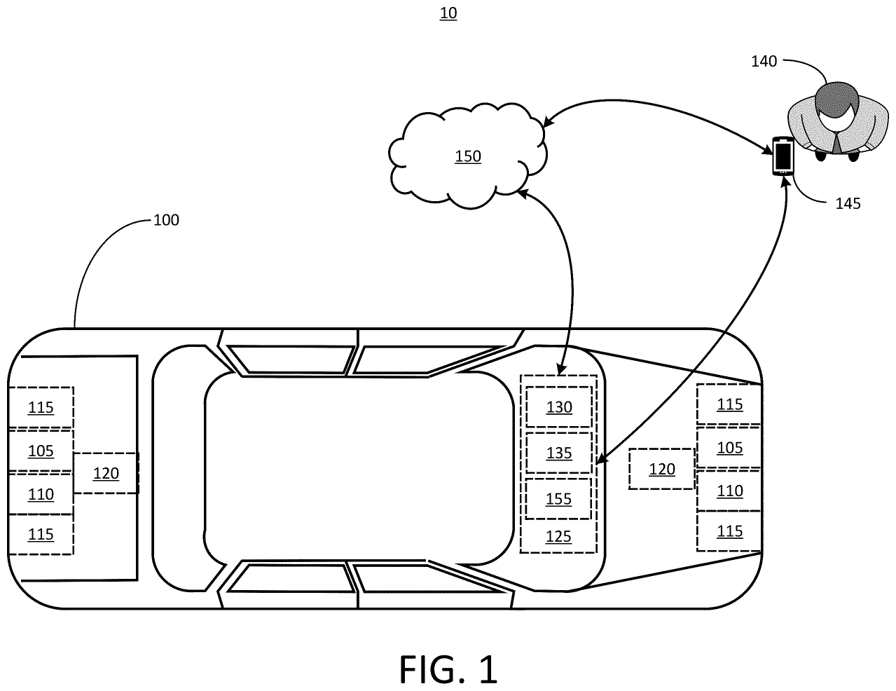

Referring now to FIG. 1, a system 10 for performing anticipatory detection of a user's need to be picked up by an autonomous vehicle and performing one or more vehicle actions in conjunction with this anticipatory detection is illustratively depicted, in accordance with an exemplary embodiment of the present disclosure.

According to an exemplary embodiment, the system comprises a vehicle 100, one or more users 140, and one or more smart devices 145 (e.g., a smart phone, tablet computer, laptop computer, and/or other suitable device) in electronic communication with the vehicle 100.

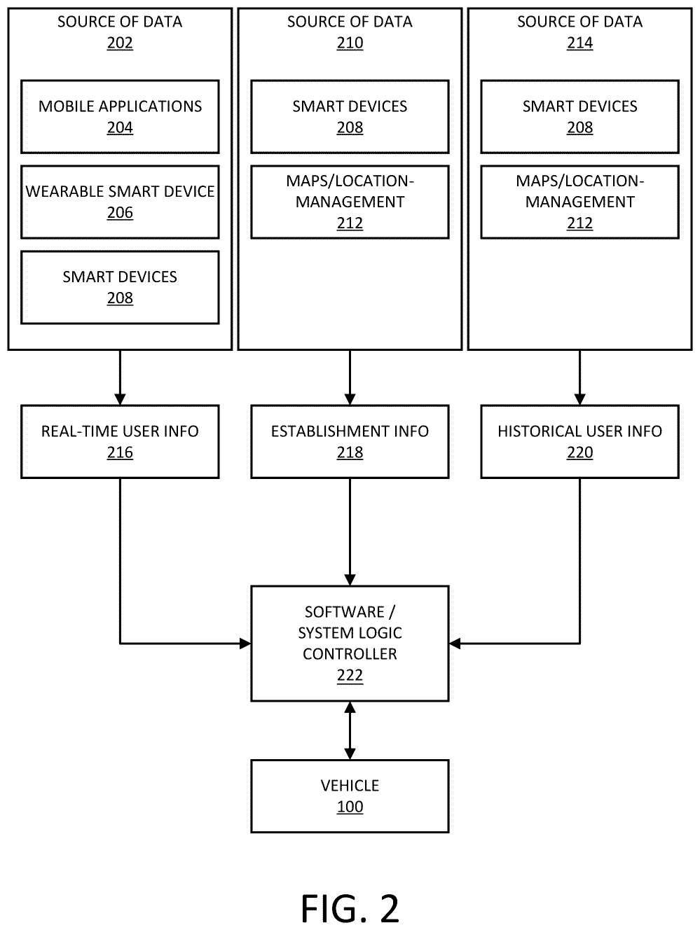

The vehicle 100 may be an autonomous vehicle, a semi-autonomous vehicle, and/or other suitable vehicle. According to an exemplary embodiment, the vehicle 100 may comprise one or more sensors such as, for example, one or more LiDAR sensors 105, one or more radio detection and ranging (RADAR) sensors 110, one or more cameras 115, and/or one or more position determining sensors 120 (e.g., one or more Global Positioning System devices), among other suitable sensors According to an exemplary embodiment, the one or more sensors may be in electronic communication with one or more computing devices 125. The one or more computing devices 125 may be separate from the one or more sensors and/or may be incorporated into the one or more sensors. According to an exemplary embodiment, the one or more smart devices 145 may be in wired and/or wireless communication (either direct and/or via one or more intermediaries such as, e.g., the cloud 150 and/or other suitable communication means) with the one or more computing devices 125. According to an exemplary embodiment, the vehicle 100 and/or one or more computing devices 125 may comprise one or more transceivers 155 configured to send and/or receive digital information through, e.g., the cloud 150. According to an exemplary embodiment, data from the vehicle 100 and/or the one or more smart devices 145 may be used to calculate a possible need for a pick-up based on an index value (trigger value). Sources of data are shown, e.g., in the logic schematic of FIG. 2.

As shown in FIG. 2 the data may comprise real-time user information 216, establishment information 218, and historical user information 220. According to an exemplary embodiment, three main areas of components feed information/data into the collective information sub-sections 216, 218, 220. These areas of components are known sources of data.

According to an exemplary embodiment, a first source of data 202 may feed into the real-time user information 216. The first source of data 202 may comprise data from one or more mobile applications 204, data from one or more wearable smart devices 206 (e.g., smart device 145), one or more smart devices 208 (e.g., smart device 145) and/or other suitable pieces and/or sources of data. According to an exemplary embodiment, the one or more wearable smart devices 206 and/or one or more smart devices (e.g., smart devices 145, 208) may comprise one or more health/fitness devices, smart phones, laptops, desktops, tablets, smart wearables, bio-modifications, and/or other suitable smart technologies.

According to an exemplary embodiment, a second source of data 210 may feed into the establishment information 218. The second source of data 210 may comprise data from one or more smart devices 208 (e.g., smart device 145), one or more maps/location management applications and/or devices 212, and/or other suitable pieces and/or sources of data.

According to an exemplary embodiment, a third source of data 214 may feed into the historical user information 220. The third source of data 214 may comprise data from one or more smart devices 208 (e.g., smart device 145), one or more maps/location management applications and/or devices 212, and/or other suitable pieces and/or sources of data.

According to an exemplary embodiment, the data may flow to a smart wearable and/or software/system logic controller 222. The logic controller 222 may be configured to generate and send a signal and/or request to the vehicle 100 instructing the vehicle 100 to pick up the user.

According to an exemplary embodiment, the logic controller 222 may be configured to generate and/or calculate a trigger value.

According to an exemplary embodiment, the vehicle 100 may be configured to determine whether the trigger value passes a threshold, and generate an acknowledgment of the pick-up after the trigger value passes a threshold.

According to an exemplary embodiment, when a vehicle 100 is parked, the real-time user information 216, establishment information 218, and historical user information 220 may be gathered once the user exits the vehicle 100. According to an exemplary embodiment, the real-time user information 216, establishment information 218, and historical user information 220 is gathered continuously once the user exits the vehicle 100.

According to an exemplary embodiment, the real-time user information 216, establishment information 218, and historical user information 220 are known sources of data. The real-time user information 216 may be new data that is being received from the user. The establishment information 218 may be data regarding the destination of the user, collected and anonymized from multiple users over time. The historical user information 220 may be data of the user's historical patterns.

According to an exemplary embodiment, the data may be processed in conjunction with machine learning to calculate a likelihood of a pick-up request for a user. Through the machine learning, the system 10 may be configured to recognize prior patterns and behaviors of a visited destination to more accurately predict pick-ups. According to an exemplary embodiment, for new destinations, the system 10 may use a wide array of data inputs as compared to previously visited destinations. According to an exemplary embodiment, certain segments of data may be given a higher value than others based on reliability to contribute to the anticipation of a pick-up trigger value.

According to an exemplary embodiment, default weightings of data may dynamically change based on the behavior of users. According to an exemplary embodiment, no two users will have the same calculation to anticipate a pick-up request. According to an exemplary embodiment, the default weightings may be dynamically tuned via machine learning of user behavior.

According to an exemplary embodiment, the system 10 and associated logic may be applied to ride-share applications and services, robo-taxi applications and services, and/or other suitable applications and services such as, but not limited to, bike-sharing, e-scooter sharing, car-sharing, etc.

According to an exemplary embodiment, none of the data originates from, or needs to originate from, within the vehicle 100, eliminating the need for one or more vehicle sensors to anticipate pick-up of the user. For example, according to an exemplary embodiment, if a user is anticipated to head to a vehicle for pick-up, the system may utilize existing biometric/location sensors on the user to anticipate the parking pick-up. It is noted, however, that other means of automatically determining a pick-up of a user and/or of data collection may be utilized, while maintaining the spirit and functionality of the present disclosure.

According to an exemplary embodiment, the computing device 125 and/or the system logic controller 222 may comprise a processor 130 and/or a memory 135. The memory 135 may be configured to store programming instructions that, when executed by the processor 130, may be configured to cause the processor 130 to perform one or more tasks such as, e.g., determining whether an autonomous vehicle (AV) is parked, determining a location of the AV, determining whether, based on the location of the AV, a pick-up can be utilized, determining whether a pick-up is required, analyzing stored data and/or collected/generating data pertaining to a user destination, an establishment/destination, and a user, calculating a trigger value, performing one or more calculation parameters to dynamically adjust the trigger value, determining whether the trigger value is greater than a threshold value, triggering an AV pick-up, and/or performing one or more vehicle actions (e.g., performing the AV pick-up, applying generative braking, adjusting a speed of the vehicle, etc.), among other functions.

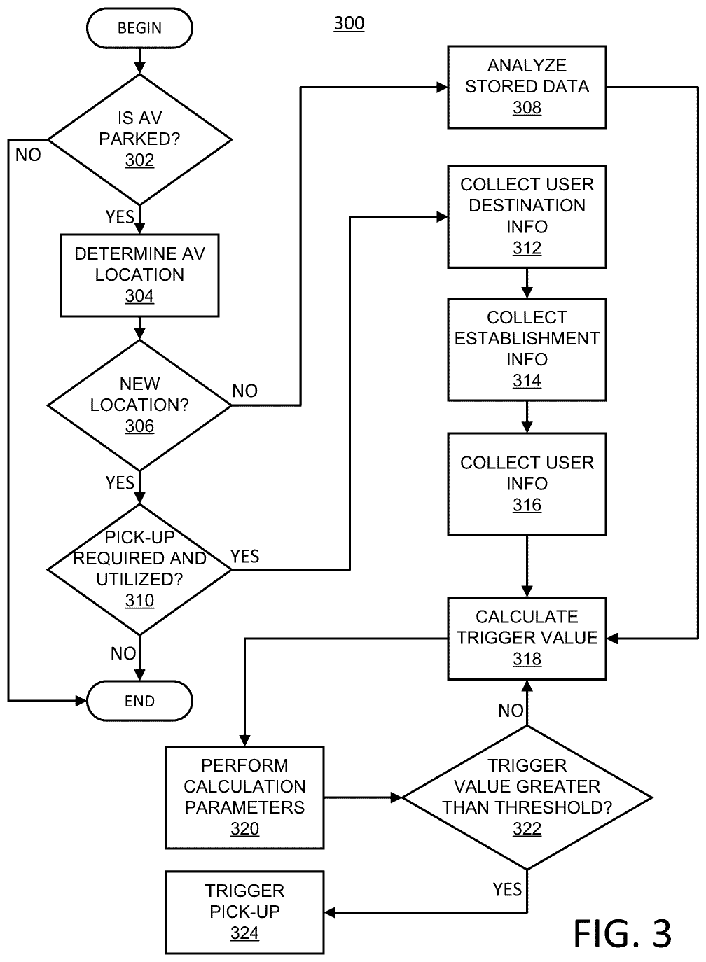

Referring now to FIG. 3, a flowchart of a method 300 for performing anticipatory detection of a user's need to be picked up by an autonomous vehicle and performing one or more vehicle actions in conjunction with this anticipatory detection is illustratively depicted, according to an exemplary embodiment of the present disclosure.

At 302, it is determined whether an autonomous vehicle (AV) is parked. According to an exemplary embodiment, when the AV is not parked, the method ends. According to an exemplary embodiment, when the AV is parked, then, at 304, a parking location of the AV is determined.

According to an exemplary embodiment, the parking location of the AV may be determined using, e.g., sensors such as GPS sensors, camera sensors, and/or other suitable location-determining sensors. According to an exemplary embodiment, the determining the parking location of the AV may comprise determining a type of parking spot at which the AV is currently parked (e.g., a driveway, a parking lot, street parking, a parking garage, etc.).

According to an exemplary embodiment, at 306, it may be determined whether the location of the AV is a new location. According to an exemplary embodiment, when the location of the AV is not a new location, stored data pertaining to that location may be analyzed, at 308, which may then be used to calculate a trigger value, at 318.

According to an exemplary embodiment, when the location of the AV is a new location, then, at 310, it is determined whether this new location can utilize remote parking pick-up and whether pick-up is required at the location. According to an exemplary embodiment, determining whether the location can utilize remote parking pick-up comprises determining whether the parking location meets predefined criteria such as, but not limited to, an ability of the AV to park at a destination, a distance from the destination, and/or other suitable criteria. For example, a pick-up may be required at a location when the parking spot location is a minimum threshold distance from the destination and not required when the parking spot location is not a minimum threshold distance from the destination. According to an exemplary embodiment, when the new location cannot utilize remote parking pick-up and/or pick-up is not required, the method ends.

According to an exemplary embodiment, when pick-up is required at the location, data is collected pertaining to the utilization of the pick-up. This data collection comprises, but is not limited to, collecting user destination information, at 312, collecting establishment information, at 314, and collecting user information, at 316. This data may be used to calculate the trigger value, at 318.

According to an exemplary embodiment, user destination information may be collected and/or determined based on parking spot location and user info such as location, etc. According to an exemplary embodiment, once the user destination is determined, data specific to the establishment may be collected, at 314, and data related user information may be collected, at 316. Establishment information may comprise, but is not limited to, establishment hours of operation, historical data such as, e.g., an average time the user or other people have spent at the establishment previously, and/or other suitable information. User information may comprise, but is not limited to, real-time information pertaining to the user (e.g., user digital behavior, user vital signs/data, voice recognition, payments, and/or other suitable real-time information), historical information pertaining to the user (e.g., user historical travel data, establishment visit frequency, duration of visits, and/or other suitable historical information) and/or other suitable data pertaining to the user. According to various embodiments, one or more components of the data may be tracked and/or collected by the AV.

According to an exemplary embodiment, with machine learning and pattern recognition, the AV may be configured to be able to recognize a user's behavior and anticipate a pick-up based on the collected data. For example, if an establishment is repeatedly visited by the user, then the logic may recognize that and more accurately anticipate a pick-up request.

According to an exemplary embodiment, using machine learning and pattern recognition, the system, at 318, may calculate the trigger value. According to an exemplary embodiment, data inputs that contribute to the trigger value are calculated based on a weight of likelihood of signaling a request for pick-up, according to behavioral patterns. Once the trigger value is calculated, one or more calculation parameters, at 320, are performed.

The trigger value is indicative of a percent likelihood that a pick-up request is required. According to various embodiments, the calculation parameters dynamically adjust the trigger value based on the one or more data points collected and/or generated.

According to an exemplary embodiment, once the calculation parameters are performed, then, at 322, it is determined whether the trigger value is greater than a threshold. When the trigger value exceeds the threshold then, at 318, the trigger value is once again calculated. When the trigger value does not exceed the threshold then, at 324, remote parking pick-up is triggers, causing the AV to begin anticipatory remote parking pick-up.

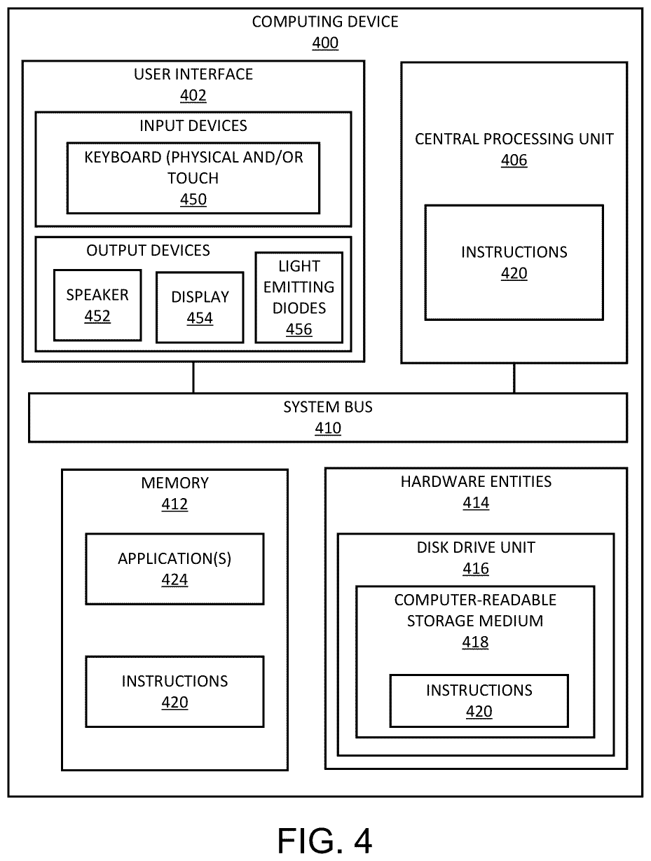

Referring now to FIG. 4, an illustration of an example architecture for a computing device 400 is provided. According to an exemplary embodiment, one or more functions of the present disclosure may be implemented by a computing device such as, e.g., computing device 400 or a computing device similar to computing device 400.

The hardware architecture of FIG. 4 represents one example implementation of a representative computing device configured to perform one or more methods and means for performing anticipatory detection of a user's need to be picked up by an autonomous vehicle and performing one or more vehicle actions in conjunction with this anticipatory detection, as described herein. As such, the computing device 400 of FIG. 4 may be configured to implement at least a portion of the method(s) described herein (e.g., method 300 of FIG. 3) and/or implement at least a portion of the functions of the system(s) described herein (e.g., system 100 of FIG. 1).

Some or all components of the computing device 400 may be implemented as hardware, software, and/or a combination of hardware and software. The hardware may comprise, but is not limited to, one or more electronic circuits. The electronic circuits may comprise, but are not limited to, passive components (e.g., resistors and capacitors) and/or active components (e.g., amplifiers and/or microprocessors). The passive and/or active components may be adapted to, arranged to, and/or programmed to perform one or more of the methodologies, procedures, or functions described herein.

As shown in FIG. 4, the computing device 400 may comprise a user interface 402, a Central Processing Unit (“CPU”) 406, a system bus 410, a memory 412 connected to and accessible by other portions of computing device 400 through system bus 410, and hardware entities 414 connected to system bus 410. The user interface may comprise input devices and output devices, which may be configured to facilitate user-software interactions for controlling operations of the computing device 400. The input devices may comprise, but are not limited to, a physical and/or touch keyboard 440. The input devices may be connected to the computing device 400 via a wired or wireless connection (e.g., a Bluetooth® connection). The output devices may comprise, but are not limited to, a speaker 442, a display 444, and/or light emitting diodes 446.

At least some of the hardware entities 414 may be configured to perform actions involving access to and use of memory 412, which may be a Random Access Memory (RAM), a disk driver and/or a Compact Disc Read Only Memory (CD-ROM), among other suitable memory types. Hardware entities 414 may comprise a disk drive unit 416 comprising a computer-readable storage medium 418 on which may be stored one or more sets of instructions 420 (e.g., programming instructions such as, but not limited to, software code) configured to implement one or more of the methodologies, procedures, or functions described herein. The instructions 420 may also reside, completely or at least partially, within the memory 412 and/or within the CPU 406 during execution thereof by the computing device 400.

The memory 412 and the CPU 406 may also constitute machine-readable media. The term “machine-readable media”, as used here, refers to a single medium or multiple media (e.g., a centralized or distributed database, and/or associated caches and servers) that store the one or more sets of instructions 420. The term “machine-readable media”, as used here, also refers to any medium that is capable of storing, encoding or carrying a set of instructions 420 for execution by the computing device 400 and that cause the computing device 400 to perform any one or more of the methodologies of the present disclosure.

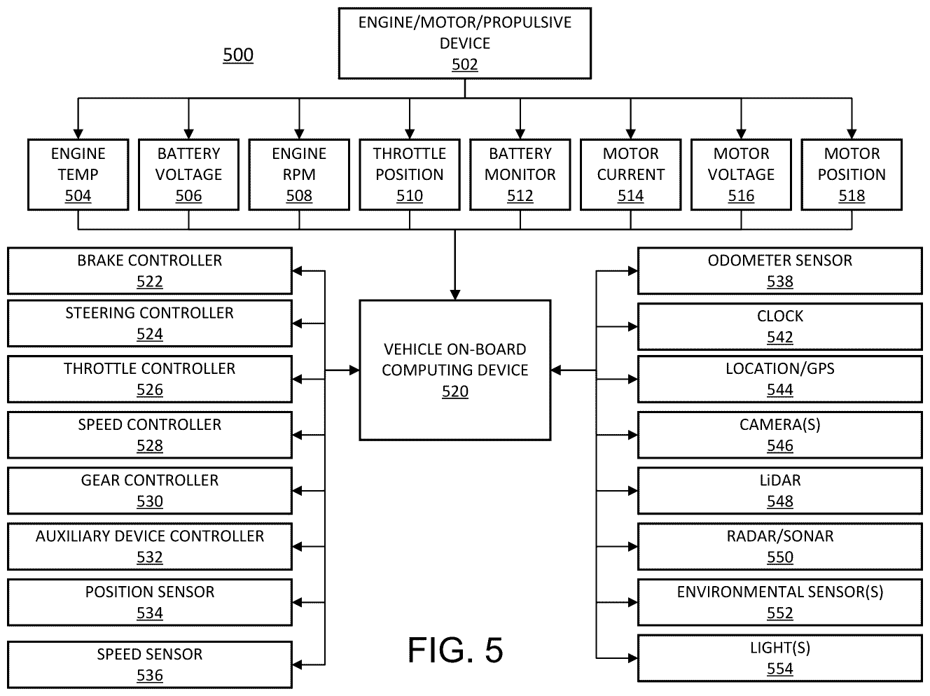

Referring now to FIG. 5, an example vehicle system architecture 500 for a vehicle is provided, in accordance with an exemplary embodiment of the present disclosure.

Vehicle 100 may be configured to be incorporated in or with a vehicle having the same or similar system architecture as that shown in FIG. 5. Thus, the following discussion of vehicle system architecture 500 is sufficient for understanding one or more components of vehicle 100.

As shown in FIG. 5, the vehicle system architecture 500 may comprise an engine, motor or propulsive device (e.g., a thruster) 502 and various sensors 504-518 for measuring various parameters of the vehicle system architecture 500. In gas-powered or hybrid vehicles having a fuel-powered engine, the sensors 504-518 may comprise, for example, an engine temperature sensor 504, a battery voltage sensor 506, an engine Rotations Per Minute (RPM) sensor 508, and/or a throttle position sensor 510. If the vehicle is an electric or hybrid vehicle, then the vehicle may comprise an electric motor, and accordingly may comprise sensors such as a battery monitoring system 512 (to measure current, voltage and/or temperature of the battery), motor current 514 and voltage 516 sensors, and motor position sensors such as resolvers and encoders 518.

Operational parameter sensors that are common to both types of vehicles may comprise, for example, a position sensor 534 such as an accelerometer, gyroscope and/or inertial measurement unit; a speed sensor 536; and/or an odometer sensor 538. The vehicle system architecture 500 also may comprise a clock 542 that the system uses to determine vehicle time and/or date during operation. The clock 542 may be encoded into the vehicle on-board computing device 520, it may be a separate device, or multiple clocks may be available.

The vehicle system architecture 500 also may comprise various sensors that operate to gather information about the environment in which the vehicle is traveling. These sensors may comprise, for example, a location sensor 544 (for example, a Global Positioning System (GPS) device); object detection sensors such as one or more cameras 546; a LIDAR sensor system 548; and/or a RADAR and/or a sonar system 550. The sensors also may comprise environmental sensors 552 such as, e.g., a humidity sensor, a precipitation sensor, a light sensor, and/or ambient temperature sensor. The object detection sensors may be configured to enable the vehicle system architecture 500 to detect objects that are within a given distance range of the vehicle in any direction, while the environmental sensors 552 may be configured to collect data about environmental conditions within the vehicle's area of travel. According to an exemplary embodiment, the vehicle system architecture 500 may comprise one or more lights 554 (e.g., headlights, flood lights, flashlights, etc.).

During operations, information may be communicated from the sensors to an on-board computing device 520 (e.g., computing device 400 of FIG. 4). The on-board computing device 520 may be configured to analyze the data captured by the sensors and/or data received from data providers and may be configured to optionally control operations of the vehicle system architecture 500 based on results of the analysis. For example, the on-board computing device 520 may be configured to control: braking via a brake controller 522; direction via a steering controller 524; speed and acceleration via a throttle controller 526 (in a gas-powered vehicle) or a motor speed controller 528 (such as a current level controller in an electric vehicle); a differential gear controller 530 (in vehicles with transmissions); and/or other controllers. The brake controller 522 may comprise a pedal effort sensor, pedal effort sensor, and/or simulator temperature sensor, as described herein.

Geographic location information may be communicated from the location sensor 544 to the on-board computing device 520, which may then access a map of the environment that corresponds to the location information to determine known fixed features of the environment such as streets, buildings, stop signs and/or stop/go signals. Captured images from the cameras 546 and/or object detection information captured from sensors such as LiDAR 548 may be communicated from those sensors to the on-board computing device 520. The object detection information and/or captured images may be processed by the on-board computing device 520 to detect objects in proximity to the vehicle. Any known or to be known technique for making an object detection based on sensor data and/or captured images may be used in the embodiments disclosed in this document.

What has been described above includes examples of the subject disclosure. It is, of course, not possible to describe every conceivable combination of components or methodologies for purposes of describing the subject matter, but it is to be appreciated that many further combinations and permutations of the subject disclosure are possible. Accordingly, the claimed subject matter is intended to embrace all such alterations, modifications, and variations that fall within the spirit and scope of the appended claims.

In particular and in regard to the various functions performed by the above described components, devices, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter.

The aforementioned systems and components have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components. Any components described herein may also interact with one or more other components not specifically described herein.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

Thus, the embodiments and examples set forth herein were presented in order to best explain various selected embodiments of the present invention and its particular application and to thereby enable those skilled in the art to make and use embodiments of the invention. However, those skilled in the art will recognize that the foregoing description and examples have been presented for the purposes of illustration and example only. The description as set forth is not intended to be exhaustive or to limit the embodiments of the invention to the precise form disclosed.

What is claimed is:

1. A method for performing anticipatory detection of a user's need to be picked up by an autonomous vehicle (AV), comprising:
using a computing device, comprising a processor and a memory:
determining a location of an AV;
determining whether a pick-up is required at the location;
when a pick-up is required at the location, collecting data pertaining to a user and a destination;
based on the data, calculating a trigger value,
wherein the trigger is indicative of a percent likelihood that a pick-up request is required;
determining whether the trigger value is greater than a threshold value; and
when the trigger value is greater than the threshold value, triggering the pick-up, causing the AV to perform the pick-up.

2. The method of claim 1, wherein the determining the location of the AV comprises determining whether the AV is parked.

3. The method of claim 1, wherein the determining whether a pick-up is required at the location comprises determining whether the parking location meets predefined criteria.

4. The method of claim 1, wherein the data pertaining to the user comprises one or more of the following:
user digital behavior data;
user physiological data;
user voice recognition data;
user payment histories; and
user historical travel data.

5. The method of claim 1, wherein the data pertaining to the destination comprises one or more of the following:
historical data comprising:
whether the user has been to the destination before;
an average timeframe of how long the user has visited the destination during a trip to the destination; and
an average timeframe of how long an average customer visits the destination during a trip to the destination;
data pertaining to whether the destination is an establishment; and
when the destination is an establishment, hours of operation of the establishment.

6. The method of claim 1, wherein the calculating the trigger value comprises:
performing one or more calculation parameters based on the data to dynamically adjust the trigger value.

7. The method of claim 1, further comprising, when the trigger value is not greater than the threshold value, recalculating the trigger value.

8. A system for performing anticipatory detection of a user's need to be picked up by an autonomous vehicle (AV), comprising:
an AV, comprising:
a processor;
a memory; and
one or more location sensors,
wherein the processor is configured to:
determine, using the one or more location sensors, a location of the AV;
determine whether a pick-up is required at the location;
when a pick-up is required at the location, collect data pertaining to a user and a destination;
based on the data, calculate a trigger value,
wherein the trigger is indicative of a percent likelihood that a pick-up request is required;
determine whether the trigger value is greater than a threshold value; and
when the trigger value is greater than the threshold value, trigger the pick-up, causing the AV to perform the pick-up.

9. The system of claim 8, wherein the determining the location of the AV comprises determining whether the AV is parked.

10. The system of claim 8, wherein the determining whether a pick-up is required at the location comprises determining whether the parking location meets predefined criteria.

11. The system of claim 8, wherein the data pertaining to the user comprises one or more of the following:
user digital behavior data;
user physiological data;
user voice recognition data;
user payment histories; and
user historical travel data.

12. The system of claim 8, wherein the data pertaining to the destination comprises one or more of the following:
historical data comprising:
whether the user has been to the destination before;
an average timeframe of how long the user has visited the destination during a trip to the destination; and
an average timeframe of how long an average customer visits the destination during a trip to the destination;
data pertaining to whether the destination is an establishment; and
when the destination is an establishment, hours of operation of the establishment.

13. The system of claim 8, wherein the calculating the trigger value comprises:
performing one or more calculation parameters based on the data to dynamically adjust the trigger value.

14. The system of claim 8, wherein, when the trigger value is not greater than the threshold value, the processor is further configured to recalculate the trigger value.

15. A system for performing anticipatory detection of a user's need to be picked up by an autonomous vehicle (AV), comprising:
an AV, comprising one or more location sensors; and
a computing device, comprising a processor and a memory, configured to store programming instructions that, when executed by the processor, cause the processor to:
determine, using the one or more location sensors, a location of the AV;
determine whether a pick-up is required at the location;
when a pick-up is required at the location, collect data pertaining to a user and a destination;
based on the data, calculate a trigger value,
wherein the trigger is indicative of a percent likelihood that a pick-up request is required;
determine whether the trigger value is greater than a threshold value; and
when the trigger value is greater than the threshold value, trigger the pick-up, causing the AV to perform the pick-up.

16. The system of claim 15, wherein the determining the location of the AV comprises determining whether the AV is parked.

17. The system of claim 15, wherein the determining whether a pick-up is required at the location comprises determining whether the parking location meets predefined criteria.

18. The system of claim 15, wherein:
the data pertaining to the user comprises one or more of the following:
user digital behavior data;
user physiological data;
user voice recognition data;
user payment histories; and
user historical travel data, and
the data pertaining to the destination comprises one or more of the following:
historical data comprising:
whether the user has been to the destination before;
an average timeframe of how long the user has visited the destination during a trip to the destination; and
an average timeframe of how long an average customer visits the destination during a trip to the destination;
data pertaining to whether the destination is an establishment; and
when the destination is an establishment, hours of operation of the establishment.

19. The system of claim 15, wherein the calculating the trigger value comprises:
performing one or more calculation parameters based on the data to dynamically adjust the trigger value.

20. The system of claim 15, wherein, when the trigger value is not greater than the threshold value, the programming instructions, when executed, further cause the processor to recalculate the trigger value.
